(19) United States
(12) Patent Application Publication
(10) Pub. No.: US 2026/0079252 A1
(43) Pub. Date: Mar. 19, 2026

(54) WEAPON DETECTION DEVICE

(71) Applicant: ELAZERSAFE LLC, West Palm Beach, FL (US)

(72) Inventor: Roy Joe Dixon, JR., West Palm Beach, FL (US)

(21) Appl. No.: 19/333,676

(22) Filed: Sep. 19, 2025

Related U.S. Application Data
(60) Provisional application No. 63/696,547, filed on Sep. 19, 2024.

(51) Int. Cl. G01S 13/88; G01S 7/02; G01S 7/36; G01S 7/41; G01S 13/86; G08B 3/10

(52) U.S. Cl. CPC G01S 13/887; G01S 7/021; G01S 7/0231; G01S 7/028; G01S 7/36; G01S 7/411; G01S 7/417; G01S 13/867; G08B 3/10

(57) ABSTRACT

A discrete wireless miniature non-imaging millimeter wave radar sensors scanning device that detects concealed weapons hidden under humans clothing. The detection sensors include a scanning device integrated with a miniature millimeter wave radar, and an AI MM-wave laser beam camera with diffractive reflector optical lens, by converting radio waves imagery of concealed weapons from the field of view to a recording medium. The wireless miniature non-imaging millimeter wave radar sensors device works in conjunction with the AI MM-wave laser beam camera, which works as a countermeasure against laser jamming. The AI Laser camera automatically activates the built-in-polarization system when it detects radar jamming and changes the polarization light waves passing through the millimeter diffractive optical lenes.

### PRIORITY CLAIM

In accordance with 37 C.F.R. § 1.76, a claim of priority is included in an Application Data Sheet filed concurrently herewith. Accordingly, the present invention claims priority to U.S. Provisional Patent Application No. 63/696,547 entitled “WEAPON DETECTION SYSTEM”, filed Sep. 19, 2024. The contents of which the above referenced application is incorporated herein by reference.

### FIELD OF THE INVENTION

The invention is directed toward school safety and, in particular, to a weapon detection system.

### BACKGROUND OF THE INVENTION

Schools have a fundamental responsibility to ensure the safety and well-being of students while they are under their care. Implementing safety measures, such as weapons screenings, is one way schools can fulfill this duty. These preventive measures not only help protect students from potential harm but also reassure parents and the school community that proactive steps are being taken to prevent dangerous situations. When parents and students feel confident in the school's commitment to safety, it fosters a more positive and focused learning environment, where the fear of violence is minimized and students can better concentrate on their education.

However, the implementation of strict security measures, such as weapons screenings, camera surveillance, and the presence of armed guards, can also have unintended psychological consequences. While such measures may promote a safer physical environment, they can create a sense of constant oversight that students may find intrusive or unsettling. The knowledge that their every movement is being monitored can lead to feelings of anxiety, discomfort, and loss of autonomy. This heightened surveillance may inadvertently suggest to students that their school is not a safe place and requires extreme measures to maintain order.

Moreover, the visible presence of armed guards or other security personnel can instill a perception of danger, reinforcing the idea that the school is at high risk for violence or other threats. This can shift the school atmosphere from one of safety to one of fear, where students may feel more like they are in a high-security zone than a place of learning. While security measures are essential for preventing real threats, it is important to balance these precautions with strategies that maintain a supportive and welcoming school climate.

### SUMMARY OF THE INVENTION

Disclosed is a discrete wireless miniature non-imaging millimeter wave radar sensor scanning device that detects concealed weapons. The wireless device detects concealed weapons such as guns and knives in backpacks, briefcases, and explosives and drugs hidden under humans clothing. The wireless miniature non-imaging MM-wave radar weapons detection sensors scanning device is integrated with a miniature millimeter wave radar, and an AI MM-wave laser beam camera with diffractive reflector optical lens, which works by converting radio waves imagery of concealed weapons from the field of view to a recording medium. The wireless miniature non-imaging millimeter wave radar sensor device works in conjunction with the AI MM-wave laser beam camera, which works as a countermeasure against laser jamming. The AI Laser camera automatically activates the built-in-polarization system when it detects radar jamming and changes the polarization light waves passing through the millimeter diffractive optical lens, and filters out unwanted signals. If a jammer and receiver do not have the same polarization the jamming signals will incur a loss that reduces its effectiveness.

An objective of the invention is to provide a wireless miniature non-imaging millimeter wave radar weapon(s) detection sensor device that is wireless, cost effective to manufacture, and does not have to be plugged into an AC power circuit.

Another objective of the invention is to provide imaging millimeter wave radar weapon detection sensors that can operate on an IP Network power source and/or solar power source.

Still another objective of the invention is to provide a miniature non-imaging millimeter wave radar weapon detection sensor scanning devices that can be discretely installed at public and private schools or the like educational facilities instructing impressionable students.

Other objectives and advantages of this invention will become apparent from the following description taken in conjunction with any accompanying drawings wherein are set forth, by way of illustration and example, certain embodiments of this invention. Any drawings contained herein constitute a part of this specification, include exemplary embodiments of the present invention, and illustrate various objects and features thereof.

### BRIEF DESCRIPTION OF THE DRAWINGS

FIG. 1 External Perspective View;

FIG. 2 Exploded View;

FIG. 3 Electrical Block Diagram;

FIG. 4 Radar Field Coverage Diagram Illustrates hemispherical radar detection zone;

FIG. 5A Radar Detection pictorial side view;

FIG. 5B Radar Detection pictorial front view;

FIG. 6 Encrypted Communication View;

FIG. 7 Timing Detection Sequence View.

### DETAILED DESCRIPTION OF THE PREFERRED EMBODIMENT

Detailed embodiments of the instant invention are disclosed herein, however, it is to be understood that the disclosed embodiments are merely exemplary of the invention, which may be embodied in various forms. Therefore, specific functional and structural details disclosed herein are not to be interpreted as limiting, but merely as a basis for the claims and as a representation basis for teaching one skilled in the art to variously employ the present invention in virtually any appropriately detailed structure

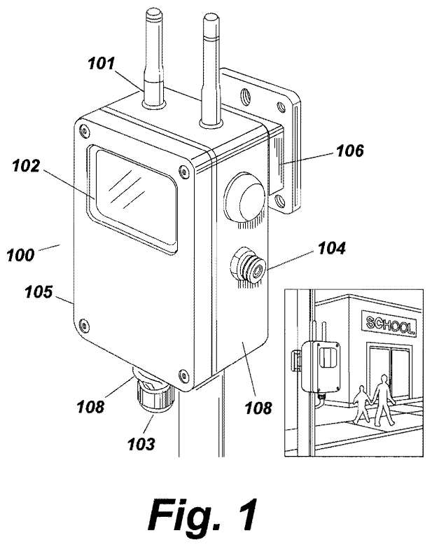

Referring to the Figs in general and FIG. 1 in particular, illustrated is a perspective view of the detection device (100) having a Dual 5G antennae (101), with a front optical window (102), IP Network Power cable import port for AI camera, mmWave radar radome (103), solar connector import port (104), front view rectangular enclosure housing cover (105), mounting bracket (106), side view rectangular enclosure cover (107, lock nut import (108).

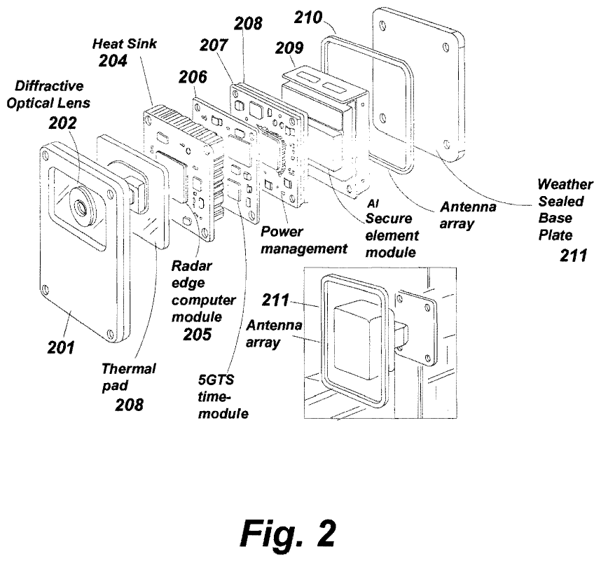

FIG. 2 is an exploded view depicting a front rectangular housing cover (201), AI-driven camera diffractive optical lens (202), Thermal pad (203), Heat sink (204), mmWave AI Edge radar processor board module (205), 5G Time Stamp module (206), Power Management system (207), Thermal pad (208), AI secure element module (209), antenna array (210), and weather-sealed base plate (211).

An AI-driven Camera Diffractive Optical Lens System (202) provides independent corroboration wherein if the mmWave radar is jammed (noise/saturation), the camera provides independent detection/visual confirmation and can maintain tracking using vision or thermal fusion. This reduces false negatives/positives. AI models trained on fused radar and camera features can detect the statistical signatures of jamming (e.g., sudden wideband noise, loss of coherent returns) and automatically switch to camera centric perception and resilient radar modes. Once jamming is detected, firmware can (a) change radar waveform (frequency hopping/chirp variation), (b) lower radar duty or use adaptive filtering, and (c) rely more on camera (DOE-enabled computational imaging) for local detection until RF environment clears.

The thermal pads (203) serves as the interface material between heat-generating components and the heat sink. The thermal pads fill microscopic air gaps between processors, radar chips, and the heat sink. This improves conductivity by creating a direct thermal pathway from the component to the sink. The thermal pad cushions and protect the radar edge compute module sensor chips while still transferring heat. The Thermal pads are engineered to conduct heat but insulate electrically, preventing short circuits between the heat sink and circuit board.

Heat Sink Thermal Management system (204), the mmWave radar, AI camera processor, 5G modem, and edge compute board all generate heat during continuous operation. The heat sink prevents overheating, absorbs and disperses this heat away from sensitive components. Sustained overheating can degrade radar signal accuracy, cause thermal noise in the AI optics, and shorten semiconductor lifespan. The heat sink maintains optimal operating temperature ranges, preventing shutdowns or failure.

Stable temperatures reduce electronic noise and drift in the radar front-end and AI vision processing, ensuring precise detection of concealed weapons. By keeping processors, RF amplifiers, and power regulators cool, the heat sink extends the service life of the device, especially important for 24/7 deployment in schools, airports, or border security. Since the radar sensor is miniaturized for discreet mounting, airflow is limited. The heat sink acts as a passive cooling system to handle hotspots without requiring bulky fans.

The mmWave AI Edge Radar Processor Board Module (205) combines radar signal processing, AI analytics, and edge computing. The module receives raw analog signals from the mmWave radar front-end. Performs ADC conversion, filtering, FFT (Fast Fourier Transform), Doppler analysis, and object detection. Extracts range, velocity, and motion signatures of concealed weapons or suspicious items. Integrates a neural network accelerator or AI inference engine. Uses machine learning models trained to distinguish between weapons, harmless objects, and human movement patterns. Fuses radar signatures with the AI-driven optical/laser camera feed for multi-sensor verification (reducing false alarms). Processes data locally on the device instead of sending raw data to the cloud. Enables real-time weapon detection with low latency, critical for security in schools, airports, stadiums, and border checkpoints. Reduces network load and protects privacy, since sensitive video/radar data does not need to leave the device.

Using 5G/Network Integration, the module interfaces with the SG modem and IP network power source. Sends alerts, metadata, and detection events to command dashboards, without transmitting heavy raw data streams. Manages power consumption, self-diagnostics, and system health monitoring. Coordinates between radar, AI camera, antennas, and thermal management.

The SG Time Stamp Module System (206) assigns a precise time marker to every radar detection, AI classification, and camera capture. This ensures that weapon detection alerts are aligned across multiple deployed devices in schools, airports, stadiums, or border checkpoints. Leverages SG ultra-low-latency network timing protocols (such as IEEE 1588 Precision Time Protocol and 3GPP defined timing sync). Maintains sub-millisecond synchronization between distributed 5G mmWave radar weapon detection devices. Provides auditable time-stamped logs of security events, essential for law enforcement investigations or courtroom evidence. Prevents disputes over when an incident occurred by tying detections to a secure network-synchronized clock. Synchronizes radar, optical AI camera, and other sensor inputs to a common time base. Enables accurate correlation of radar signatures with visual evidence (e.g., weapon shape in camera plus radar Doppler signature at the same exact moment).

The module integrates with cryptographic protocols to ensure that time-stamped events cannot be falsified or altered. Supports secure blockchain-style event logging for chain-of-custody in threat detection. Works in both online (5G-connected) and offline (local clock) modes. The module reconciles logs with the network clock to ensure continuity of data.

The Power Management System (207) comprises an IP-network power interface configured to receive DC power over a network cable from a Power Sourcing Equipment (PSE) and to provide power to internal subsystems. The IP-network power interface includes an IEEE 802.3af/at/bt compliant Powered Device (PD) controller, isolation magnetics and surge protection. The PD output is coupled to a power conditioning module comprising DC converters and a battery charging circuit. The power conditioning module is coupled to a battery management system configured to selectively supply power to or draw charge from an onboard rechargeable battery, wherein, upon loss of power from the PSE, the battery management system automatically powers device loads without interruption.

PD negotiation compliant with targeted PoE standard (af/at/bt). RJ45 with outdoor-rated gland or use an external PoE surge-protected injector for pole mounts. Solation barrier between Ethernet pairs and sensitive RF (mmWave) ground.

Power budgeting for radar, AI, SOC, 5G modem, peripherals, and peak transmit bursts. The power is designed for peak use and a safety margin. Battery BMS and MPPT solar controller if solar is integrated. Firmware: auto-failover, graceful throttling of AI/radar on low power, remote power control via SNMP/REST. Environmental: conformal coating, temp-rated capacitors (especially for high-temp furnace-like environments).

AI Secure Element Module Function (209) provides a tamper-resistant hardware vault for storing private keys, encryption certificates, and authentication credentials. This ensures secure access to 5G networks, school safety dashboards, and government security infrastructure. Verifies that the device only runs authentic, untampered firmware and AI models at startup. Prevents hackers from injecting malicious code into the radar or AI camera pipeline. Stores and protects proprietary ElazerSafe's AI weapon detection models against reverse engineering or theft. Ensures only authorized updates and retrained models can be loaded. Ensures that radar signatures, camera data, and detection events are processed and transmitted with encryption. Prevents spoofing or man-in-the-middle attacks on 5G or IP networks. Provides device identity verification when connecting to command centers or cloud services. Ensures only authenticated users (e.g., school security, law enforcement) can access logs and live alerts.

AI Secure Element Module Function detects and responds to physical tampering attempts (e.g., drilling, voltage glitching, probing). Can lock down or wipe cryptographic secrets if intrusion is detected. Works with the 5G Time Stamp Module to ensure all detection logs are cryptographically signed and time stamped. Provides an unbroken forensic record admissible in court or government investigations.

Antenna Array Function (210) generates and receives millimeter-wave signals (24-100 GHz range) used for weapon detection. Provides beamforming capability to steer radar signals and scan a wide hemispherical detection zone without mechanical movement. Detects range, velocity, and motion signatures of concealed objects with high precision. Works in coordination with the AI-driven optical/laser camera, ensuring that radar coverage overlaps the camera's field of view. Enhances multi-sensor fusion for accurate classification of potential threats.

5G antennas to maintain ultra-low-latency network connections. Ensures reliable, high-speed transmission of alerts, metadata, and event logs to monitoring dashboards. Supports seamless connectivity in high-density environments like schools, airports, and stadiums. Employs frequency agility and adaptive beam steering to reduce susceptibility to radar jammers or spoofing devices. Ensures reliable detection in contested or high-RF environments.

The weather-sealed base plate provides a seal against water, dust, and debris (compliant with IP65/IP66 standards for rugged electronics). Prevents moisture ingress that could damage sensitive electronics, including radar modules, AI cameras, and edge processors. Forms the foundation of the enclosure, securing internal components such as the heat sink, processor board, antennas, and power modules. Ensures that the device maintains its structural integrity during vibrations, impacts, or outdoor exposure. Works with the heat sink and thermal pads to maintain proper thermal contact. Ensures heat generated by processors, radar modules, and AI cameras is efficiently transferred to the heat sink. Acts as a partial electromagnetic interference (EMI) shield, protecting sensitive RF circuitry from external noise.

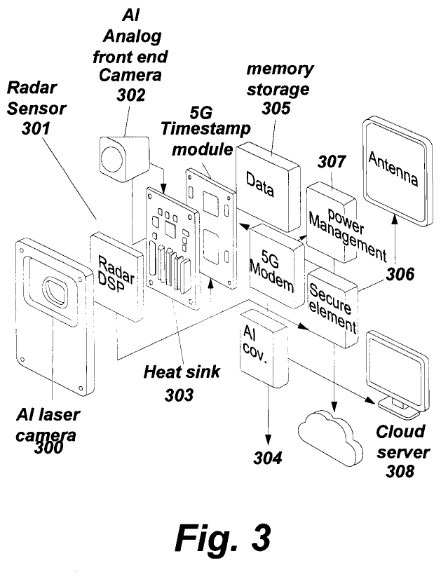

FIG. 3 is a block diagram depicting the AI lens Camera (300), Radar sensor processing (DSP) (301), connects to analog front end-to-digital (302), Heat Sink (303), Data converter Back end-to-digital AI converter (304), MCU/AI processor memory storage Data (305), antenna system (306), 5G modem Power management (307), Cloud Server (308).

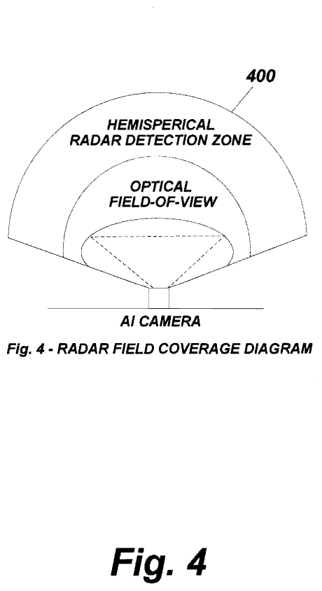

FIG. 4 is a diagram of the radar field coverage to illustrate hemispherical radar detection zone (400) from the camera.

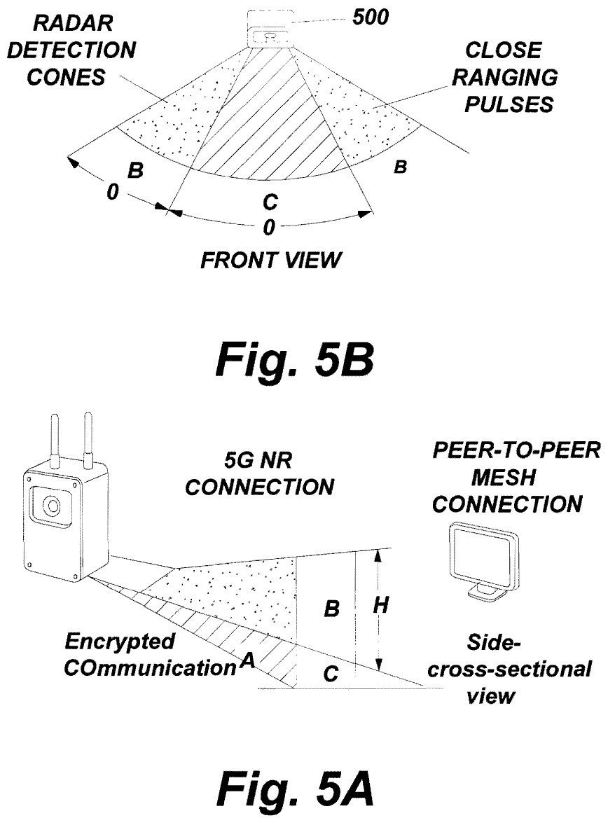

FIG. 5A depicts a cross section side view of the peer to peer mesh connection of a 5G NR connection and the height (H) of connection illustrated by zones A, C and B.

FIG. 5B is a front view of the radar (500) with detection zones depicted by A and C for close ranging pulses, zone B is the front view.

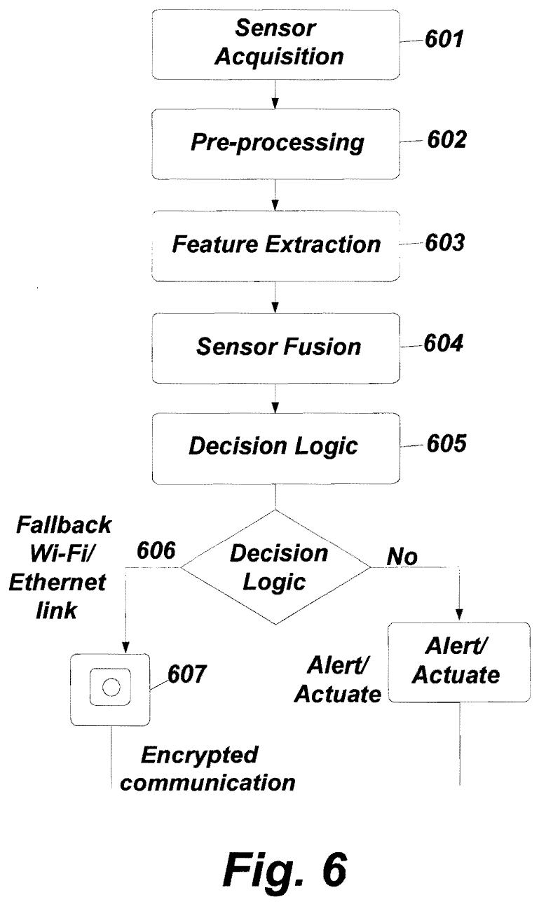

FIG. 6 is an Encrypted Communication View and operational steps of the scanning device. Sensor acquisition (601) is a miniature non-imaging millimeter wave radar sensor. Pre-processing (602) of the signal received by the sensor acquisition. Feature extraction (603) from an emitted Millimeter Wave Signals. The radar sensor emits millimeter wave signals to penetrate clothing and detect concealed weapons. Sensor fusion (604) wherein reflected signals from concealed items is obtained. Decision logic (605) analyze the reflected signals and set off an alert or send an encrypted communication.

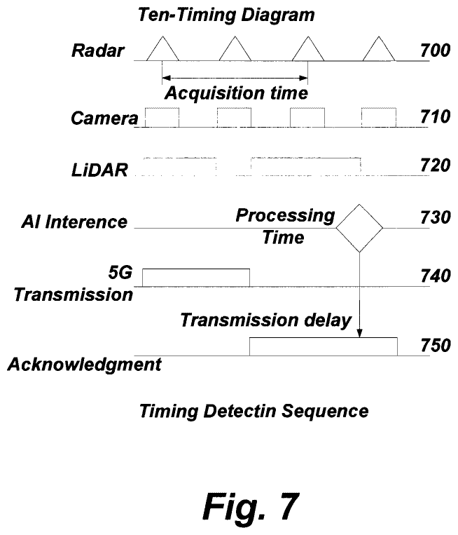

FIG. 7 illustrated the timing detection sequence view using radar (700), camera (710), LiDAR (720) AI Inference processing time (730), 5G transmission (740) and Acknowledgment (750).

The device is a wireless scanning system designed to detect concealed weapons hidden beneath clothing. This device system combines a miniature non-imaging millimeter wave radar sensor with an advanced AI-driven millimeter wave laser beam camera. The radar sensor scans for concealed weapons by emitting millimeter wave signals that penetrate clothing, and the reflected waves are analyzed to create an image of any hidden items. This imagery is then transmitted to a recording medium for further examination. The device features an integrated AI-powered laser camera equipped with diffractive reflector optical lenses, enhancing its ability to accurately detect and identify concealed objects. To counteract potential interference from laser jamming, the system includes a built-in polarization mechanism. When the AI camera detects any form of radar jamming, it automatically activates this polarization system. This system adjusts the polarization of the light waves passing through the millimeter wave optical lenses, effectively filtering out the interference and maintaining accurate detection capabilities.

Millimeter-wave (mmWave) radar operates by emitting electromagnetic waves in the millimeter-wave frequency range, typically between 30 GHz and 300 GHz, corresponding to wavelengths between 1 mm and 10 mm. These waves have high-frequency and short wavelengths, allowing the radar to provide high-resolution sensing for detecting and tracking objects.

The radar emits mmWave signals in a specific direction. These signals travel through clothing until they encounter a reflective object. When the transmitted mmWave signals hit an object, such as a weapon, some of the signals are reflected back toward the radar. The radar's receiver detects these reflected signals. The time it takes for the signal to return helps determine the distance of the object from the radar.

Advanced algorithms process the reflected signals to estimate the size and shape of the item. Using Artificial Intelligence “AI” the program learns which items are reflective, but not considered weapons or drugs, so as to learn from the signals received making less stoppage for the students. This allows the students using the same items on a daily basis, such as a metal wallet to be allowed passage without hesitation. The high resolution mmWave frequencies provide better resolution than lower-frequency radars, enabling precise detection of small objects. mmWave can penetrate clothing and track multiple objects at once with high precision. An audio can be employed to announce “WEAPON IS DETECTED” upon identifying a weapon, “CONTRABAND IS DETECTED” upon identifying illegal drugs, or the like announcement. The announcement may also be sent through the IT connection to a remote monitoring station for an audible as well as visual alert.

The term “coupled” is defined as connected, although not necessarily directly, and not necessarily mechanically. The use of the word “a” or “an” when used in conjunction with the term “comprising” in the claims and/or the specification may mean “one,” but it is also consistent with the meaning of “one or more” or “at least one.” The use of the term “or” in the claims is used to mean “and/or” unless explicitly indicated to refer to alternatives only or the alternative are mutually exclusive, although the disclosure supports a definition that refers to only alternatives and “and/or.”

The terms “comprise” (and any form of comprise, such as “comprises” and “comprising”), “have” (and any form of have, such as “has” and “having”), “include” (and any form of include, such as “includes” and “including”) and “contain” (and any form of contain, such as “contains” and “containing”) are open-ended linking verbs. As a result, a method or device that “comprises,” “has,” “includes” or “contains” one or more steps or elements, possesses those one or more steps or elements, but is not limited to possessing only those one or more elements. Likewise, a step of a method or an element of a device that “comprises,” “has,” “includes” or “contains” one or more features, possesses those one or more features, but is not limited to possessing only those one or more features. Furthermore, a device or structure that is configured in a certain way is configured in at least that way, but may also be configured in ways that are not listed.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

What is claimed is:

1. A weapon detection device comprising:
a miniature wireless non-imaging millimeter wave radar scanning sensor, integrated with an AI-driven millimeter wave laser beam camera featuring diffractive optical lenses configured to transmit non-imaging millimeter wave signals representing hidden weapons to a recording medium, and equipped with an audio alarm system that announces “WEAPON IS DETECTED” upon identifying a weapon;
a 5G mmWave radar transceiver array housed within a weatherproof enclosure; an AI-driven laser optical camera mounted adjacent to the radar array;
an edge computing module configured for local signal processing and AI inference;
a 5G modem and antenna system for secure data transmission;
a power subsystem including rechargeable battery and solar input port; and
a mounting bracket for attachment to a pole, wall, or drone platform.

2. The weapon detection device according to claim 1 further comprising a 5G communication module configured to transmit live video alerts and location telemetry.

3. The weapon detection device according to claim 1 wherein said wave radar scanning sensor array detects concealed metallic and non-metallic weapons by measuring reflectivity patterns across a frequency band of 24-81 GHz and conveys non-imaging MMradio waves signals imagery to a recording medium and to a smartphone app providing an audio voice memory alarm.

4. The weapon detection device according to claim 1 wherein said wave radar scanning sensor is integrated with an AI-driven camera, which uses multispectral imaging to confirm weapon signatures detected by the radar.

5. The weapon detection device according to claim 1 wherein said wave radar scanning sensor includes diffractive optical lens for polarization to filter out jamming.

6. The weapon detection device according to claim 1 wherein said wave radar scanning sensor conveys electromagnetic communication to an IP Network power source.

7. The weapon detection device according to claim 1 wherein the enclosure measures less than 6 inches on its longest dimension, making it portable and easily deployable.

8. The weapon detection device according to claim 1 wherein said wave radar scanning sensor including a relay to deactivate electronic door(s) sensors from operating.

9. The weapon detection device according to claim 1 including at least one integrated oscillator transceivers which conveys electromagnetic communication to an IP Network circuit.

10. The weapon detection device according to claim 1 wherein said device is constructed and arranged for placement onto walls, brick pillars, sports stadium gateways, poles and doors.

11. The weapon detection device according to claim 1 wherein said audio announces “WEAPON IS DETECTED” upon identifying a weapon.

12. The weapon detection device according to claim 1 wherein said audio announces “CONTRABAND IS DETECTED” upon identifying illegal drugs.

13. The weapon detection device according to claim 1 wherein the power subsystem includes a solar charging connector port enabling off-grid operation.

14. A method of weapon detection comprising the steps of:
coupling a compact, wireless scanning device to a solar power panel or an IP Network Power Source;
activating the miniature non-imaging millimeter wave radar sensor;
emitting millimeter wave signals from said radar sensor capable of penetrating clothing and detecting concealed weapons and drugs;
receive reflected signals from concealed items; analyzing the reflected signals to create an image of any hidden objects;
sending the generated imagery to a recording medium for further examination;
integrating an AI-driven millimeter wave laser beam camera with diffractive reflector optical lenses into the examination;
detecting, through said AI camera, potential radar jamming; automatically activating a built-in polarization system to counteract the detected jamming;
adjust polarization of the light waves passing through the millimeter wave optical lenses; filter out interference from jamming;
continue scanning and detecting concealed weapons and drugs with reduced interference;
AI learning from said step of scanning to classify non weapons and drugs as interference and disregard in future scanning.
